(19) United States
(12) Patent Application Publication
(10) Pub. No.: US 2024/0281217 A1
(43) Pub. Date: Aug. 22, 2024

(54) PROJECTOR AND CONTROL METHOD THEREOF

(71) Applicant: Coretronic Corporation, Hsin-Chu (TW)

(72) Inventors: Tzu-Hai Chung, Hsin-Chu (TW); Chun-Yi Lee, Hsin-Chu (TW); Yung-Feng Lin, Hsin-Chu (TW); Chia-Chun Chang, Hsin-Chu (TW)

(73) Assignee: Coretronic Corporation, Hsin-Chu (TW)

(21) Appl. No.: 18/434,792

(22) Filed: Feb. 6, 2024

(30) Foreign Application Priority Data
Feb. 16, 2023 (CN) 202310122888.5

(51) Int. Cl. G06F 8/30

(52) U.S. Cl. CPC G06F 8/31

(57) ABSTRACT

A projector and a control method are provided. The projector includes a control unit, a storage medium, and a projection module. The control unit includes a script interpreter. The control method includes: detecting whether a first script is stored in the storage medium by the control unit when the projector is in an operation state, in which the first script includes a first script language instruction; interpreting the first script through the script interpreter so as to obtain the first script language instruction in response to the first script being stored in the storage medium; and configuring a display parameter of the projection module according to the first script language instruction, in which the projection module plays a multimedia file according to the display parameter.

### CROSS-REFERENCE TO RELATED APPLICATION

This application claims the priority benefit of China application serial no. 202310122888.5, filed on Feb. 16, 2023. The entirety of the above-mentioned patent application is hereby incorporated by reference herein and made a part of this specification.

### BACKGROUND

### Technical Field

The disclosure relates to a projection technology, and in particular, to a projector and a control method thereof.

### Description of Related Art

In general, the control logic or codes for realizing various functions of the projector are pre-written in the firmware of the projector. The content of the firmware needs to be programmed before the projector leaves the factory. Once the projector enters the market, the firmware of the projector may not be reprogrammed or modified. In this way, when a projector manufacturer develops a new function of the projector, even if the hardware of the projector purchased by the customer already supports the new function, the projector will still be limited by the old firmware and may not perform the new function.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projector and a control method thereof, which enable the projector to configure a display parameter of a projection module according to a script.

A projector of the disclosure includes: a control unit, a storage medium, and a projection module. The control unit is coupled to the storage medium and the projection module and includes a script interpreter. The control unit is configured to: detect whether the storage medium stores a first script when the projector is in an operation state, in which the first script includes a first script language instruction; interpret the first script through a script interpreter so as to obtain the first script language instruction in response to the storage medium storing the first script; and configure a display parameter of the projection module according to the first script language instruction, in which the projection module plays a multimedia file according to the display parameter.

A control method of a projector of the disclosure, in which the projector includes a control unit, a storage medium, and a projection module. The control unit is coupled to the storage medium and the projection module and includes a script interpreter. The control method includes the following steps. It is detected whether a first script is stored in the storage medium by the control unit when the projector is in an operation state, in which a first script language instruction is included in the first script; the first script is interpreted through a script interpreter so as to obtain the first script language instruction in response to the first script being stored in the storage medium; and a display parameter of the projection module is configured according to the first script language instruction, in which a multimedia file is played by the projection module according to the display parameter.

Based on the above, the projector of the disclosure may store a script interpreter. When the projector is in the start state, the operation state, or the end state, the script interpreter may parse the script corresponding to the state to obtain the script language instruction and then adjust the display parameter of the projection module according to the script language instruction. Accordingly, the user may write a script for the projector and use the script to update various functions of the projector. In addition, when the projector is in the operation state, it is also possible to write the script and update the function or the display parameter of the projector without affecting the operation of the projector.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projector according to an embodiment of the disclosure.

FIG. 2 is a flow diagram of a control method of a projector according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

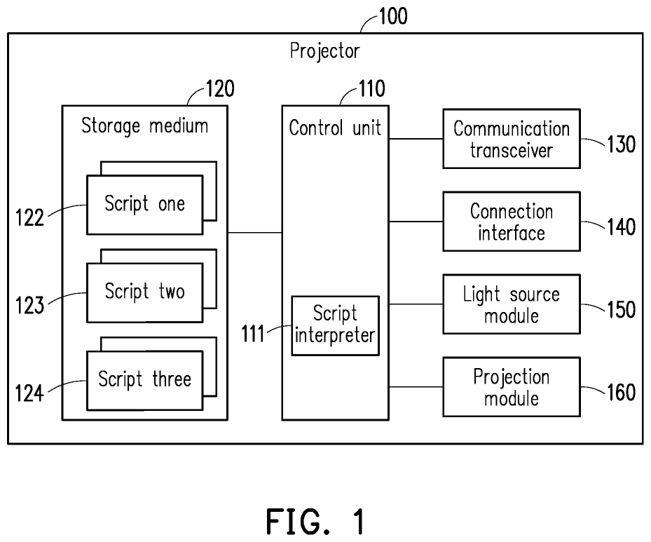

FIG. 1 is a schematic diagram of a projector 100 according to an embodiment of the disclosure. The projector 100 may include a control unit 110, a storage medium 120, a communication transceiver 130, a connection interface 140, a light source module 150, and a projection module 160. The control unit 110 is communicatively connected to the storage medium 120, the communication transceiver 130, the connection interface 140, the light source module 150, and the projection module 160.

The control unit 110 is, for example, a central processing unit (CPU) or other programmable general-purpose or special-purpose micro control unit (MCUs), a microprocessor, a digital signal processor (DSP), a programmable controller, an application specific integrated circuit (ASIC), a graphics processing unit (GPU), an image signal processor (ISP)), an image processing unit (IPU), an arithmetic logic unit (ALU), a complex programmable logic device (CPLD), a field programmable logic gate array (FPGA), other similar elements, or a combination thereof. The control unit 110 may access and execute various modules and various application programs stored in the storage medium 120. In the embodiment, the control unit 110 includes a script interpreter 111.

The storage medium 120 is, for example, any form of fixed or movable random access memory (RAM), a read-only memory (ROM), a flash memory, a hard disk drive (HDD), a solid state drive (SSD), or a similar element, or a combination thereof, and is configured to store multiple modules or various application programs that may be executed by the control unit 110. In the embodiment, the storage medium 120 may store multiple modules such as one or more scripts 122 for the startup state of the projector 100, one or more scripts 123 for the operation state of the projector 100, and one or more scripts 124 for the shutdown state of the projector 100, and the functions thereof will be described later.

The communication transceiver 130 transmits and receives signals in a wireless or wired manner. Communication transceiver 130 may also perform operations such as low noise amplification, impedance matching, frequency mixing, up or down frequency conversion, filtering, amplification, and the like. In an embodiment, the projector 100 may receive the script 122, the script 123, or/and the script 124 through the communication transceiver 130 and store the script 122, the script 123, or/and the script 124 in the storage medium 120.

The connection interface 140 may be configured to receive operations from the user and generate corresponding instructions, or to output information of the projector 100 for the user's reference. The connection interface 140 may include but is not limited to devices such as a button (e.g., power button), a keyboard, or a touch screen. The user may program the script 122, the script 123, or the script 124 through the connection interface 140. For example, the connection interface 140 may include a virtual keyboard in a touch screen. The user may operate the virtual keyboard to edit a new script or update the script 122, the script 123, or the script 124 in the storage medium 120. The script 122, the script 123, or the script 124 includes a series of instructions written in a script language, which may implement functions such as reading/writing examples, sending control instructions, comparing with expected results, and confirming execution conditions.

The light source module 150 is configured to provide an illumination beam used by the projector 100 to generate an image. The light source module 150 may include, for example, a light emitting device, a lens element or a reflector for transmitting a light beam, a dichroic element, a light combination element, a phosphor wheel, a filter wheel, or/and a light uniform element (not shown). The projection module 160 includes, for example, an imaging element and a projection lens (not shown). The imaging element in the projection module 160 is configured to modulate the illumination beam provided by the light source module 150 so as to form a modulated image, and the projection lens projects the modulated image from the imaging element out of the projector 100 to form an enlarged image. The control unit 110 may control the light source module 150 and the projection module 160 to play the multimedia file. In an embodiment, the imaging element of the projection module 160 may be an element that produces image such as a digital micromirror device (DMD), a liquid crystal display element, or a liquid-crystal-on-silicon panel (LCOS panel). The projection lens (not shown) is, for example, a combination of one or more optical lenses with diopters. The optical lenses include, for example, various combinations of non-planar lenses such as biconcave lenses, biconvex lenses, concave-convex lenses, convex-concave lenses, plano-convex lenses, or plano-concave lenses. The disclosure does not limit the form and the type of the projection lens. The projection module 160 may play the multimedia file according to the display parameter. The display parameter may include but is not limited to parameters such as RGB value, color temperature, illumination, or brightness.

When the projector 100 is in the startup state (for example: when the power of the projector 100 is turned on and the projector is about to enter the operation state), the control unit 110 may execute the script 122 for the startup state of the projector 100. Specifically, the control unit 110 may detect whether the communication transceiver 130 or the connection interface 140 receives a power-on instruction. If a power-on instruction is detected, the control unit 110 may detect whether the script 122 is stored in the storage medium 120. If the script 122 is stored in the storage medium 120, the control unit 110 interprets the script 122 in the storage medium 120 through the script interpreter 111 so as to obtain the script language instruction for the startup state. Then, the control unit 110 may configure the function or display parameter required before the projector 100 starts the operation state according to the script language instruction corresponding to the script 122. For example, the control unit 110 may configure the projector 100 to automatically adjust the position of the lens, execute specific settings, enable the remote control function, or download and adjust image display parameters according to the script language. The projector 100 may enter into the operation state after the execution of the script language instruction starts or after the execution of the script language instruction has been completed.

When the projector 100 is in the operation state, the control unit 110 may execute the script 123 for the operation state of the projector 100. Specifically, the control unit 110 may detect whether the script 123 is stored in the storage medium 120. In an embodiment, the control unit 110 may detect whether the script 123 is stored in the storage medium 120 according to a preset cycle. The control unit 110 may receive relevant information of the preset cycle through the communication transceiver 130 or the connection interface 140. If the script 123 is stored in the storage medium 120, the control unit 110 interprets the script 123 through the script interpreter 111 so as to obtain the script language instruction for the operation state. Then, the control unit 110 may configure the function or display parameter required before the projector 100 starts the operation state according to the script language instruction corresponding to the script 123. For example, the control unit 110 may configure the RGB value, color temperature, illumination, or brightness of the projector 100 according to the script language instruction so as to adjust the presentation mode of the multimedia file played by the projector 100.

In an embodiment, the control unit 110 may detect whether the user modifies or reads/writes the script 123 in the storage medium 120 through the connection interface 140. If the control unit 110 detects that the script 123 is modified or read/written, the control unit 110 may interpret the modified or read/written script 123 through the script interpreter 111 so as to obtain updated script language instruction. Then, the control unit 110 may configure the function or display parameter required before the projector 100 starts the operation state according to the updated script language instruction. In another embodiment, when the projector 100 is in the operation state, the projection module 160 is projecting images, and the control unit 110 may simultaneously detect whether the user modifies or reads/writes the script in the storage medium 120 through the connection interface 140. If the control unit 110 detects that the script is modified or read/written, the control unit 110 may interpret the modified or read/written script through the script interpreter 111 so as to obtain updated script language instruction. In addition, the projector 100 may be adjusted according to the updated script language instruction without affecting the projected image.

When the projector 100 is in the state before shutdown (for example, when the power of the projector 100 is turned off and the operation state is about to end), the control unit 110 may execute the script 124 for the shutdown state of the projector 100. Specifically, the control unit 110 may detect whether the communication transceiver 130 or the connection interface 140 receives a shutdown instruction. If the shutdown instruction is detected, the control unit 110 may detect whether the script 124 is stored in the storage medium 120. If the script 124 is stored in the storage medium 120, the control unit 110 interprets the script 124 through the script interpreter 111 so as to obtain the script language instruction for the shutdown state. Then, the control unit 110 may configure the function or display parameter required before the projector 100 ends the operation state according to the script language instruction corresponding to the script 124.

In an embodiment, the script interpreter 111 may support the following programming languages: C language, C++ language, Java language, or Python language. In other words, the user may use C language, C++ language, Java language, or Python language to edit the script 122, the script 123, or the script 124.

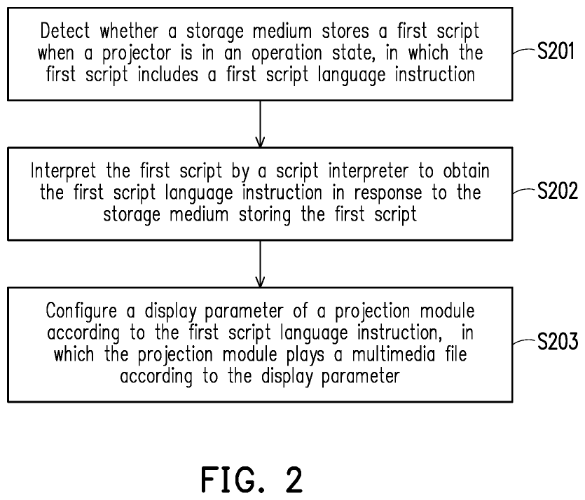

FIG. 2 is a flow diagram of a control method of a projector according to an embodiment of the disclosure. The control method may be implemented by the projector 100 shown in FIG. 1. In step S201, it is detected whether the first script is stored in the storage medium when the projector is in the operation state, in which the first script includes a first script language instruction. In step S202, the first script is interpreted by the script interpreter so as to obtain the first script language instruction in response to the first script being stored in the storage medium. In step S203, the display parameter of the projection module is configured according to the first script language instruction, in which the projection module plays the multimedia file according to the display parameter. In another embodiment of the disclosure, before step S201 or at the same time as step S201, it may be detected by the control unit whether the power-on instruction is received, and whether a second script is stored in the storage medium in response to the power-on instruction, in which the second script includes a second script language instruction; the second script is interpreted by the script interpreter so as to obtain the second script language instruction in response to the second script being stored in the storage medium; and the function required by the projector before the projector starts the operation state is configured according to the second script language instruction. In another embodiment of the disclosure, after step S203 or at the same time as step S203, it may be detected by the control unit whether a shutdown instruction is received, and whether a third script is stored in the storage medium in response to the shutdown instruction, in which the third script includes a third script language instruction; the third script is interpreted by the script interpreter so as to obtain a third script language instruction in response to the third script being stored in the storage medium; and the function required by the projector before the projector ends the operation state is configured according to the third script language instruction.

In summary, the projector of the disclosure may store a script interpreter. When the projector is in the startup state, the operation state, or the state before shutdown, the script interpreter may parse the script corresponding to the state so as to obtain the script language instruction, and then adjust the display parameter of the projector according to the script language instruction. Accordingly, the user may write a script for the projector and use the script to update various functions of the projector. Compared with the traditional method of using firmware update to expand the functions of the projector, the script of the disclosure may replace the firmware to configure various parameters of the projector. In this way, the number of firmware version updates of the projector may be reduced, and the possibility of errors caused by firmware version updates may be reduced. The projector user may change the control process of the projector by writing a script for the projector, thereby increasing the flexibility of the projector in use.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A projector, comprising: a control unit, a storage medium, and a projection module, wherein the control unit is coupled to the storage medium and the projection module, the control unit comprises a script interpreter, and the control unit is configured to:
detect whether the storage medium stores a first script when the projector is in an operation state, wherein the first script comprises a first script language instruction;
interpret the first script through the script interpreter so as to obtain the first script language instruction in response to the storage medium storing the first script; and
configure a display parameter of the projection module according to the first script language instruction, wherein
the projection module plays a multimedia file according to the display parameter.

2. The projector according to claim 1, wherein the control unit is further configured to:
detect whether the storage medium stores the first script according to a preset cycle.

3. The projector according to claim 1, wherein the control unit is further configured to:
detect whether a power-on instruction is received;
detect whether the storage medium stores a second script in response to the power-on instruction, wherein the second script comprises a second script language instruction;
interpret the second script through the script interpreter so as to obtain the second script language instruction in response to the storage medium storing the second script; and
configure a function required by the projector before the projector starts the operation state according to the second script language instruction.

4. The projector according to claim 1, wherein the control unit is further configured to:
detect whether a shutdown instruction is received;
detect whether the storage medium stores a third script in response to the shutdown instruction, wherein the third script comprises a third script language instruction;
interpret the third script through the script interpreter so as to obtain the third script language instruction in response to the storage medium storing the third script; and
configure a function required by the projector before the projector ends the operation state according to the third script language instruction.

5. The projector according to claim 1, wherein the script interpreter supports at least one of the following programming languages: C language, C++ language, Java language, and Python language.

6. The projector according to claim 1, wherein the projector further comprises a communication transceiver, the control unit is coupled to the communication transceiver, and the control unit is further configured to:
receive the first script through the communication transceiver; and
store the first script in the storage medium.

7. The projector according to claim 1, wherein the display parameter comprises at least one of the following: a RGB value, a color temperature, an illumination, and a brightness.

8. The projector according to claim 1, wherein the projector further comprises a connection interface, the control unit is coupled to the connection interface, and the control unit is further configured to:
detect whether the first script in the storage medium is modified or read/written through the connection interface; and
interpret the modified or read/written first script through the script interpreter, if yes, in response to the modified or read/written first script in the storage medium.

9. A control method of a projector, wherein the projector comprises a storage medium, a control unit, and a projection module, the control unit is coupled to the storage medium and the projection module, the control unit comprises a script interpreter, and the control method comprises:
detecting whether a first script is stored in the storage medium by the control unit when the projector is in an operation state, wherein the first script comprises a first script language instruction;
interpreting the first script through the script interpreter so as to obtain the first script language instruction in response to the first script being stored in the storage medium; and
configuring a display parameter of the projection module according to the first script language instruction, wherein
the projection module plays a multimedia file according to the display parameter.

10. The control method according to claim 9, wherein the step of detecting whether the first script is stored in the storage medium by the control unit comprises:
detecting whether the first script is stored in the storage medium according to a preset cycle.

11. The control method according to claim 9, further comprising:
detecting by the control unit whether a power-on instruction is received;
detecting whether a second script is stored in the storage medium in response to the power-on instruction, wherein the second script comprises a second script language instruction;
interpreting the second script through the script interpreter so as to obtain the second script language instruction in response to the second script being stored in the storage medium; and
configuring a function required by the projector before the projector starts the operation state according to the second script language instruction.

12. The control method according to claim 9, further comprising:
detecting by the control unit whether a shutdown instruction is received;
detecting whether a third script is stored in the storage medium in response to the shutdown instruction, wherein the third script comprises a third script language instruction;
interpreting the third script through the script interpreter so as to obtain the third script language instruction in response to the third script being stored in the storage medium; and
configuring a function required by the projector before the projector ends the operation state according to the third script language instruction.

13. The control method according to claim 9, wherein the script interpreter supports at least one of the following programming languages: C language, C++ language, Java language, and Python language.

14. The control method according to claim 9, wherein the projector further comprises a communication transceiver, and the control method further comprises:
receiving the first script through the communication transceiver; and
storing the first script in the storage medium.

15. The control method according to claim 9, wherein the display parameter comprises at least one of the following: a RGB value, a color temperature, an illumination, and a brightness.

16. The control method according to claim 9, wherein the projector further comprises a connection interface, and the control method further comprises:
modifying or reading/writing the first script in the storage medium through the connection interface; and
interpreting the modified or read/written first script through the script interpreter in response to the modified or read/written first script in the storage medium.
